(19) United States
(12) Patent Application Publication
(10) Pub. No.: US 2009/0205610 A1
(43) Pub. Date: Aug. 20, 2009

(54) Throttle Valve Control Device and Throttle Valve Control Method

(75) Inventors: Kentaro Jumonji, Bolton (GB); Shuuichi Nakano, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Chiyoda-ku, Tokyo (JP)

(21) Appl. No.: 11/884,681

(22) PCT Filed: Mar. 25, 2005
(86) PCT No.: PCT/JP2005/006442

§ 371 Date: Aug. 20, 2007

(51) Int. Cl. F02D 9/08; F02D 11/10; F02D 41/00

(52) U.S. Cl. 123/337; 123/399; 701/103

(57) ABSTRACT

A throttle valve control device for controlling an intake flow to an engine making it hard for a driver to hear return spring check sound and capable of detecting the failure of a return spring earlier by checking the return spring while the engine is operating and a throttle valve control method. To reduce the wear of the gears of the throttle valve control device, when a target throttle opening is controllably fully opened while the engine is operating, the control of a throttle valve is stopped. After the control of the throttle valve is stopped, it is checked whether or not a throttle sensor output value is equal to a throttle sensor output value at a throttle machine full open position.

### TECHNICAL FIELD

The present invention relates to a throttle control device for an internal combustion engine and its control method.

### BACKGROUND ART

A typical diesel engine operates, as shown in FIG. 1, by compressing air in a combustion chamber of the engine, injecting fuel into the air compressed and raised in temperature to cause combustion and explosion of the fuel and the air, and outputting the explosive power as the rotational motive power via the crank shaft. The exhaust gas contains a harmful substance, such as nitrogen oxides (NOx), and a precious metal catalyst is disposed in the exhaust pipe to reduce nitrogen oxides. Further, part of the exhaust gas from the combustion is recirculated to the intake pipe via an EGR valve and added to the intake air. This is for lowering the peak value of the combustion temperature and thus reducing the nitrogen oxides (NOx) in the exhaust gas by mixing the exhaust gas into the intake air.

Unlike a gasoline engine which adjusts the power by changing the intake air flow rate and the fuel injection amount, the diesel engine controls the power by adjusting the fuel injection amount, and the throttle opening by the throttle control device for the diesel engine is normally controlled to be the control full open position where the air flow rate is maximum. The throttle valve is controlled toward the closed position when to recirculate the exhaust gas to the intake pipe as described above to adjust the mixing ratio of the intake air and the exhaust gas or when to stop the engine. In other words, when the engine is in operation, the throttle opening of the throttle valve device that occurs most frequently is the control full open position.

FIG. 2 shows the construction of a throttle valve device 8. The throttle valve device comprises a throttle body 801 in which there are disposed a throttle valve 802, a motor 803 for driving the throttle valve 802, an intermediate gear 804 that transmits the motive power of the motor to the throttle valve 802 while decelerating it, a throttle return spring (referred to as return spring hereinafter) 805 that holds the throttle valve 802 in a mechanical full open position even when the throttle valve device 8 is not controlled or no driving signal is supplied to the throttle valve device 8, and a throttle sensor 806 that detects the throttle opening. Furthermore, in the throttle valve device 8, there are disposed a mechanical full close stopper 808 that stops the throttle valve 802 at a mechanical full closed position and a mechanical full open stopper 807 that prevents the throttle valve 802 from being mechanically opened substantially beyond the full open position.

FIG. 3 is a cross sectional view of the throttle valve device. Throttle control is made between the mechanical full close stopper 808 and the mechanical full open stopper 807. The position of the throttle valve is controlled between a position slightly closer to the full open position than the mechanical full close stopper 808 and a position slightly closer to the full close position than the mechanical full open stopper 807, for example, between a position where the throttle valve is opened by 0.5 degrees from the mechanical full close stopper 808 and a position where the throttle valve is closed by 0.5 degrees from the mechanical full open stopper 807. This is because, when to control the position of the throttle valve 802 to be at the position of the mechanical full close stopper, for example, the throttle valve 803 collides with the mechanical full close stopper 808 to cause hunting, so that the throttle valve 803 cannot be controlled to be at the position of the mechanical full close stopper.

As for the control full open position MaxCTP, at which the throttle valve is most frequently controlled to be, the throttle valve tends to be accurately controlled to be at the control full open position MaxCTP. As a result, particular ones of the intermediate gears or the like of the throttle control device may unusually wear. Specifically, if the throttle valve is to be accurately controlled to be at the control full open position MaxCTP, a rotating motor gear 809, or a throttle valve gear 810 and an intermediate gear 804 are rotated in forward and reverse directions with the same teeth thereof engaged with each other, and only those teeth wear.

As a measure against this, there is a method of, when controlling the throttle valve to the control full open position MaxCTP, stopping the throttle control and holding the throttle valve at the mechanical full open position MaxMTP by a return spring 805. If the throttle valve is biased in one direction toward the mechanical full open position MaxMTP by the return spring 805, the gears are prevented from always rotating in the forward and reverse directions with the same teeth engaged with each other, and thus, wear of those gears may be reduced.

A diagnosis method for the return spring 805 will be described with reference to FIG. 4. In general, the diagnosis of the return spring 805 is made by driving the throttle valve in the direction opposite to the direction of biasing by the return spring 805 and by stopping the driving of the throttle valve at a certain position to check that the throttle valve 805 returns to the default position, that is, the position of the mechanical full open stopper 807 by the biasing of the return spring 805. The diagnosis is performed at the time when the engine is stopped. If the diagnosis is made when the engine is in operation, there is fear that the diagnosis will vary the power of the engine accidentally. In order to avoid this, the diagnosis is made during the engine stop.

The diagnosis is made such that the throttle valve is driven in the direction opposite to the direction of biasing by the return spring 805, then the driving is stopped, and the throttle valve collides with the mechanical full open stopper 807. In the case where the diagnosis is performed when the engine is stopped, there is a problem that the sound of collision is clearly audible as compared with the engine sound and is offensive to the ear.

Further, there has been proposed another method of checking the return spring when abnormality occurs in the throttle driving, as described in JP-A-4-246257. In this case, even when the return spring 805 has a failure, diagnosis of the return spring is not made unless abnormality occurs in the throttle driving. Therefore, there is a problem that a return spring failure cannot be detected early.

If a return spring failure cannot be detected early, there is a possibility that, in the case where the engine is supercharged with a supercharger, when the return spring 805 is broken and the throttle valve 802 accidentally vibrates or otherwise moves to the mechanical full close position MinMTP, the supercharged intake air is blocked at the throttle valve 802 and leaks from the most fragile part of an intake path.

### DISCLOSURE OF THE INVENTION

One of typical throttle valve control devices according to the present invention comprises: a throttle valve that controls an intake air flow rate of an engine; a throttle sensor that detects an opening of the throttle valve; a spring that biases the throttle valve in one arbitrary direction; a throttle stopper that limits the range of operation of the throttle valve; a stop means that stops control and driving of the throttle valve in the case where the opening of the throttle valve is equal to or greater than a predetermined value or equal to or smaller than a predetermined value; an output value judgment means that judges whether or not an output value of the throttle sensor is equal to an output value of the throttle sensor at the time when the throttle valve lies at the throttle stopper, when the control and driving of the throttle valve is stopped; and a failure judgment means that judges that the spring for biasing in the one direction has a failure if the output value of the throttle sensor differs from the output value of the throttle sensor at the time when the throttle valve lies at the throttle stopper.

A typical throttle valve control method of the invention comprises steps of: stopping control and driving of a throttle valve in the case where a position of the throttle valve is equal to or greater than a predetermined value or equal to or smaller than a predetermined value; judging whether or not an output value of a throttle sensor is equal to an output value of the throttle sensor at the time when the throttle valve lies at a throttle stopper, when the control and driving of the throttle valve is stopped; and judging that a spring for biasing in one direction has a failure if the output value of the throttle sensor differs from the output value of the throttle sensor at the time when the throttle valve lies at the throttle stopper.

According to the invention, return spring failure diagnosis is performed when an engine is in operation, the sound of the return spring failure diagnosis can be made hardly audible, and a return spring failure can be detected earlier.

### BRIEF DESCRIPTION OF THE DRAWINGS

FIG. 1 is a block diagram showing the construction of a conventional diesel engine control system;

FIG. 2 is a view showing the construction of a throttle valve device;

FIG. 3 is a view illustrating ranges of operation of the throttle valve device;

FIG. 4 is a timing chart of a conventional return spring diagnosis;

FIG. 5 is a schematic view illustrating the diesel engine control according to the invention;

FIG. 6 is a flowchart illustrating a return spring diagnosis process of example 1;

FIG. 7 is a flowchart illustrating a return spring diagnosis process of example 2;

FIG. 8 is a flowchart illustrating a return spring diagnosis process of example 3;

FIG. 9 is a flowchart illustrating a return spring diagnosis process of example 4;

FIG. 10 is a flowchart illustrating a return spring diagnosis process of example 5; and

FIG. 11 is a flowchart illustrating a return spring diagnosis process of example 6.

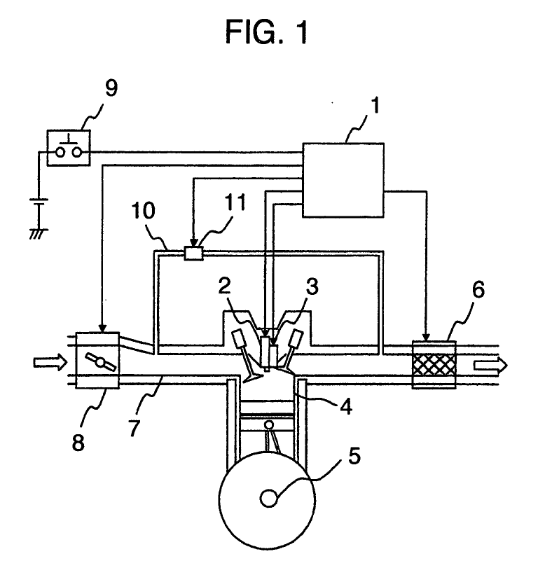

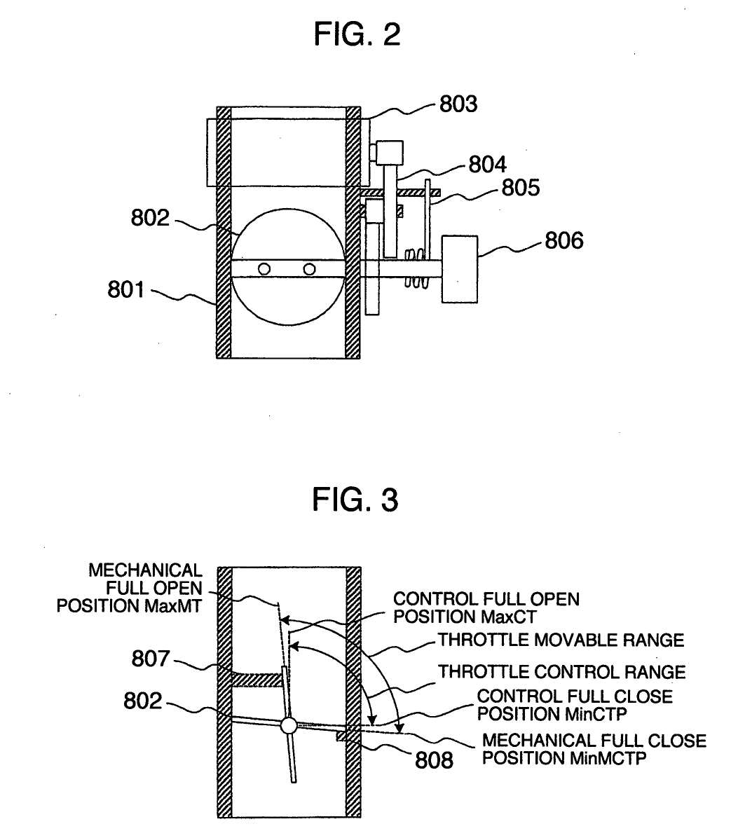

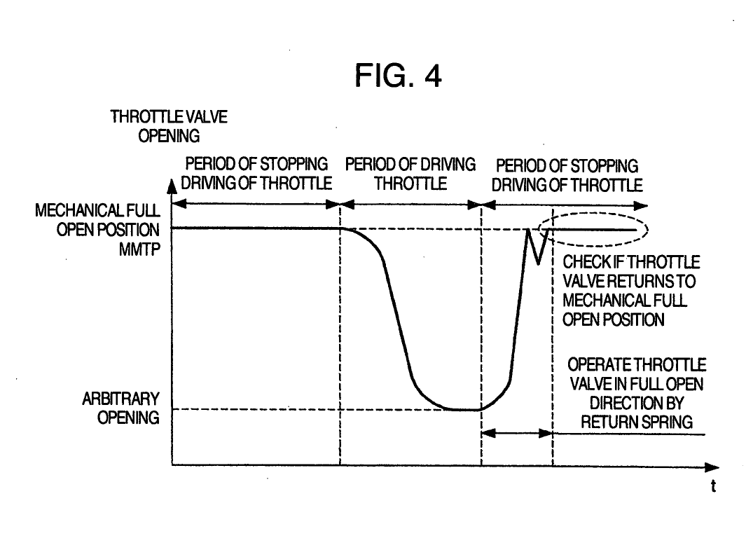

### BEST MODE FOR CARRYING OUT THE INVENTION

In the following, an embodiment of the present invention will be described with reference to examples.

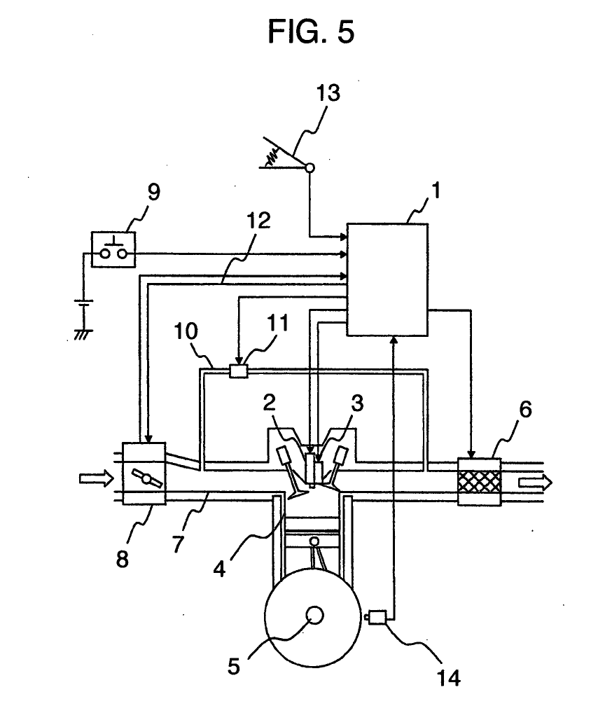

First, a system for controlling a diesel engine will be described with reference to FIG. 5. FIG. 5 is the schematic view illustrating a diesel engine control according to this embodiment. An engine control device 1 for controlling the engine is provided with an injector driver for driving a fuel injector 2, a glow plug driver for driving a glow plug 3, a control microcomputer (micon) for controlling the engine, and a motor driver for controlling a throttle valve device. The engine control device 1 obtains various kinds of sensor information from an accelerator position sensor 4 for detecting an accelerator position, a water temperature sensor, an engine rotation sensor 5 and the like, and the control microcomputer performs various kinds of calculations to determine timing for fuel injection, the duration of fuel injection, and a target throttle opening TTP. The throttle valve device 8 is controlled based on the target throttle opening TTP. The throttle opening of the throttle valve device for the diesel engine is normally controlled to be a control full open position in which the air flow rate is at the maximum. If the intake air flow does not differ between the control full open position MaxCTP and a mechanical full open position MaxMTP, the engine power does not vary depending on whether the throttle control is performed or not.

### Example 1

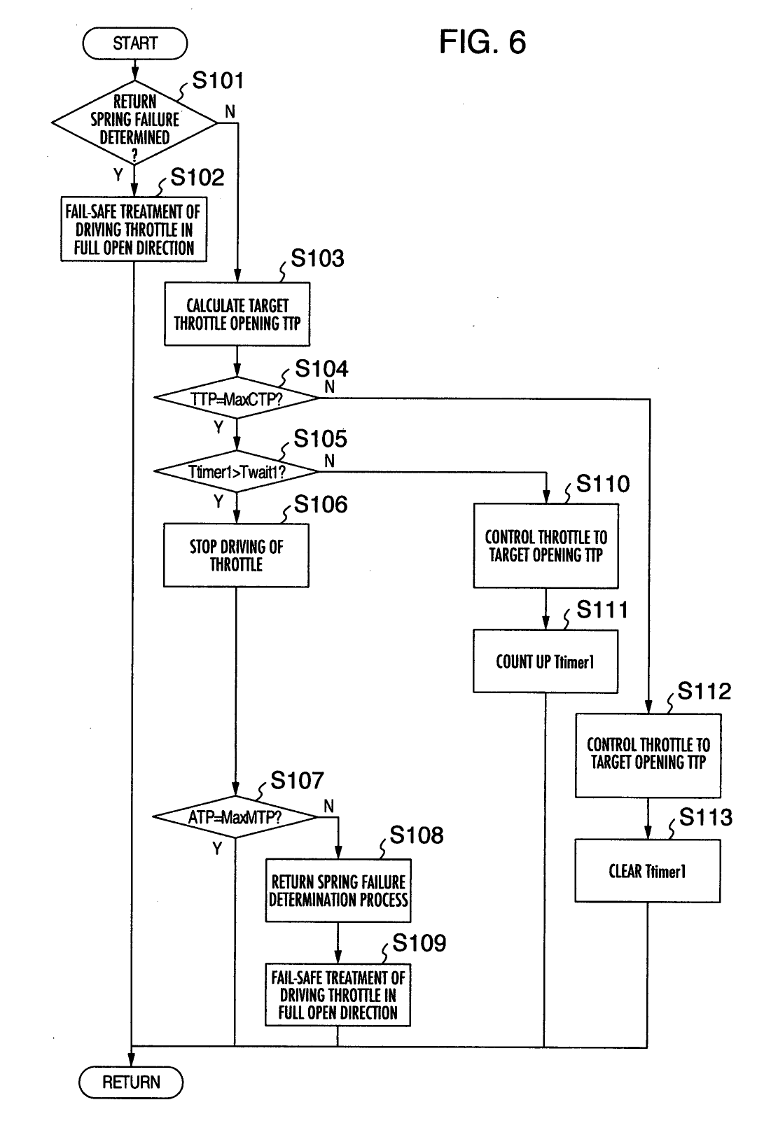

Now, a throttle control stopping means for reducing wear of gears, a return spring failure diagnosis process, and a process for driving a throttle valve toward a full open position according to example 1 of the invention will be described with reference to FIG. 6 (referred to as return spring failure diagnosis 1, hereinafter). The process according to the example 1 is repeated at regular time intervals.

First, in step S101, it is judged whether there is a return spring failure or not. If there is a return spring failure, the process proceeds to step S102, where a fail-safe treatment, such as a process for driving the throttle valve in a full open direction, is performed. If there is no return spring failure, the process proceeds to step S103.

In step S103, the target throttle opening TTP is calculated based on the various kinds of information. Then, in step S104, the target throttle opening TTP is checked to determine whether the target throttle opening TTP is at the control full open position MaxCTP or not. If the target throttle opening TTP is not at the control full open position MaxCTP, the process proceeds to step S112, where the throttle control to achieve the target throttle opening TTP is performed. If the target throttle opening TTP is at the control full open position MaxCTP, the process proceeds to step S105, where it is judged whether a time Ttimer1 for which the throttle is maintained at the control full open position MaxCTP is longer than a wait time Twait1. If Ttimer1≦Twait1, the process proceeds to steps S110 and S111, where the throttle valve 802 is controlled to be at the control full open position MaxCTP, the time Ttimer1 is counted up, and the time for which the throttle valve 802 is maintained at the control full open position MaxCTP is determined.

If Ttimer1>Twait1, the process proceeds to step S106, where the throttle control is stopped, and then the process proceeds to step S107. In step S107, it is judged whether a throttle valve opening ATP is at the mechanical full open position MaxMTP or not. If the throttle valve opening ATP is at the mechanical full open position MaxMTP, it is judged that the throttle valve 802 returns to the mechanical full open position MaxMTP by the return spring 805 and therefore the return spring 805 operates normally. In this case, a fail-safe treatment or the like is not performed. If the throttle valve opening ATP is not at the mechanical full open position MaxMTP, it is judged that the return spring 805 has a failure, and the process proceeds to steps S108 and S109. In step S108, a return spring failure determination process is performed, and in step S109, a fail-safe treatment for driving the throttle valve 802 in the full open direction is performed.

In this way, if the target throttle opening TTP is at the control full open position MaxCTP, the throttle valve 802 is controlled to be at the control full open position MaxCTP for a predetermined time, and then, the throttle control is stopped. As a result, for example, as compared with a case where the throttle control is stopped at the control full close position, the impact caused when the throttle valve 802 reaches the mechanical full open position MaxMTP can be reduced. In addition, since the return spring 805 holds the throttle valve 802 in the mechanical full open position MaxMTP, wear of gears can be reduced, as compared with a case where the throttle valve is held in the control full open position MaxCTP. Furthermore, in the period in which the throttle control is stopped, the throttle valve opening ATP may be checked, and if the throttle valve opening is not at the mechanical full open position MaxMTP, it can be judged that the throttle valve 802 cannot be held in the mechanical full open position MaxMTP because of a failure of the return spring. Thus, a failure of the return spring can be detected. In other words, in addition to the measure against wear of gears, return spring failure diagnosis can be performed even when the engine is operating. Thus, a return spring failure can be detected earlier.

As described above, according to the example 1, in the throttle valve device having the means of reducing wear of the intermediate gear 804, the motor gear 809 and the throttle gear 810 for driving the throttle valve 802, the return spring failure diagnosis is performed when the engine is in operation, while stopping the throttle control and reducing wear of the gears. As a result, the sound of the return spring failure diagnosis can be obscured with the engine sound. Furthermore, the return spring diagnosis is performed also when the engine is operating, a return spring failure can be detected earlier. Furthermore, when the return spring failure is detected, the throttle valve 802 is driven to the full open position to prevent the throttle valve 802 from moving toward the mechanical full close position. Thus, the intake path can be prevented from being damaged.

### Example 2

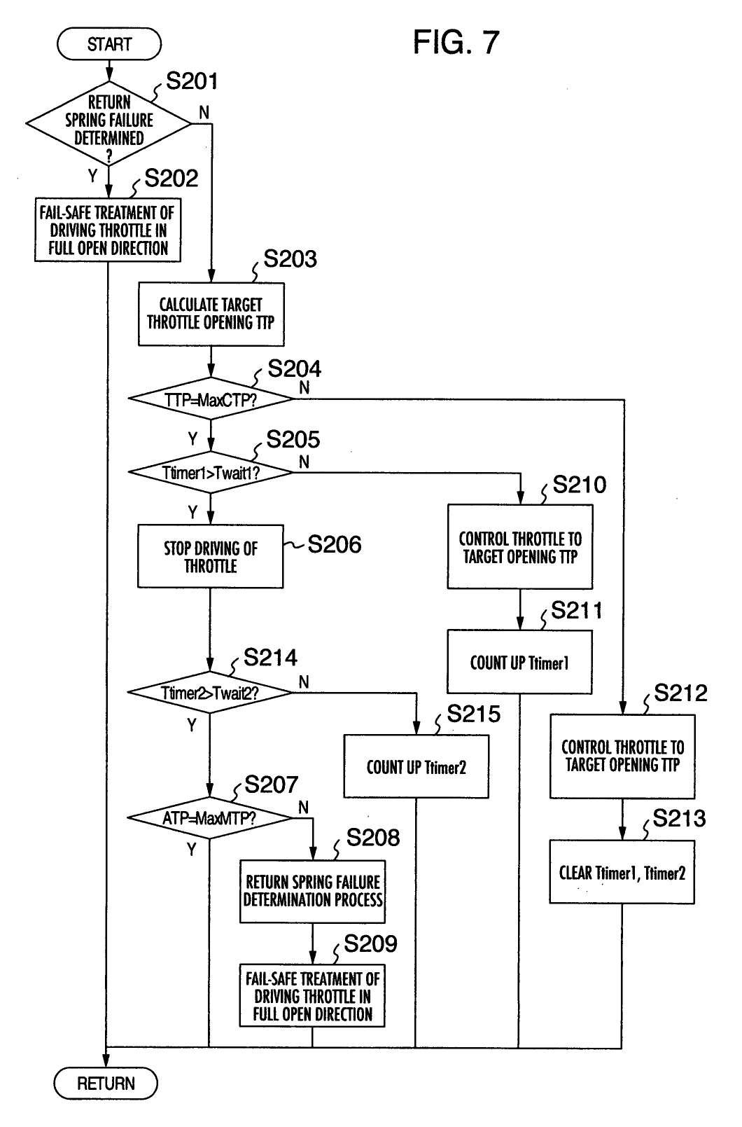

A return spring failure diagnosis process according to example 2 of the invention (referred to as return spring failure diagnosis 2, hereinafter) will be now described with reference to FIG. 7. Steps S201 to S213 in FIG. 7 are the same as steps S101 to S113 of the example 1 shown in FIG. 6.

In step S206, the throttle control is stopped, and the process proceeds to step S214. In step S214, it is determined whether a lapse time Ttimer2 after stop of the throttle control exceeds a wait time Twait2 or not. If Ttimer2≦Twait2, the process proceeds to step S215, where the lapse time Ttimer2 is counted up, and the return spring failure diagnosis 2 is ended. If Ttimer2>Twait2, the process proceeds to step S207, and the throttle valve opening ATP is checked in the same manner as the process from step S107 to step S109 in the example 1, and a fail-safe treatment or the like is performed.

In this way, after the predetermined time (Twait2) elapses from stop of the throttle control, the throttle valve opening ATP is determined to judge a return spring failure so that false detection of a return spring failure can be prevented.

For example, if the throttle valve opening ATP is checked when the throttle valve 802 is returning from the control full close position MinCTP to the mechanical full open position MaxMTP, the throttle valve opening ATP is surely not at the mechanical full open position MaxMTP. Thus, even though the throttle valve is returning to the mechanical full open position MaxMTP by the return spring 802, a return spring failure is falsely detected. If the wait time Twait2 is set at, for instance, a length of time that is required for the throttle valve 802 to return from the control full close position MinCTP to the mechanical full open position MaxMTP after the throttle control is stopped, checking of the throttle valve opening ATP is not done before the throttle valve 802 has returned to the mechanical full open position MaxMTP from any position between the control full close position MinCTP and the control full open position MaxCTP by the force of the return spring. Thus, the false detection of a return spring failure described above can be prevented.

As described above, according to the example 2, after the throttle control is stopped, the return spring failure diagnosis is stopped until a time lapses which is required for the throttle valve to return from the mechanical full close position MinMTP to the mechanical full open position MaxMTP, and after the return time elapses, the return spring failure diagnosis is performed. That is, since the return spring failure diagnosis is stopped for a time that ensures that the throttle valve returns to the mechanical full open position MaxMTP, the return spring failure diagnosis can be prevented from being performed when the throttle valve 802 is returning to the mechanical full open position MaxMTP, so that false detection of a failure can be avoided.

### Example 3

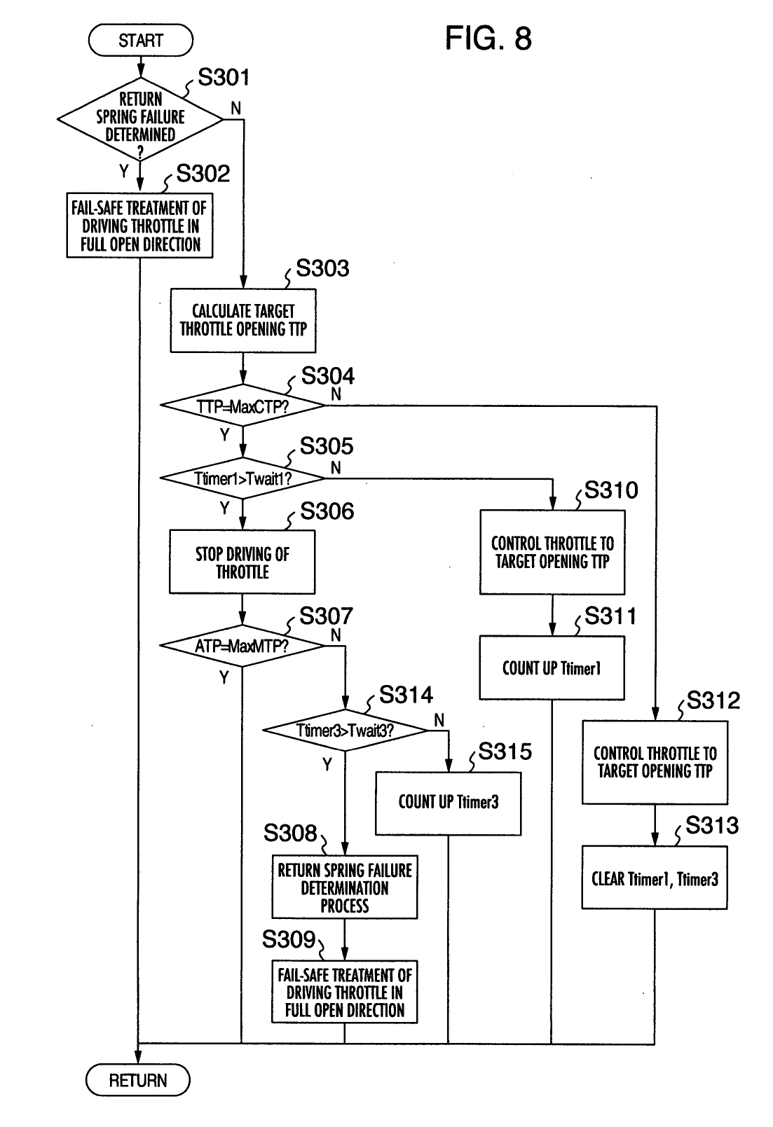

Now, a return spring failure diagnosis process according to example 3 of the invention (referred to as return spring failure diagnosis 3, hereinafter) will be described with reference to FIG. 8. Steps S301 to step S313 in FIG. 8 are the same as steps S101 to S313 of the example 1 shown in FIG. 6.

In step S306, the throttle control is stopped, and the process proceeds to step S307, where it is determined whether the throttle valve opening ATP is at the mechanical full open position MaxMTP or not. If the throttle valve opening ATP is at the mechanical full open position MaxMTP, the return spring failure diagnosis 3 is ended. If the throttle valve opening ATP is at the mechanical full open position MaxMTP, the process proceeds to step S314, where it is determined whether a time Ttimer3 for which the throttle valve opening ATP is not at the mechanical full open position MaxMTP exceeds a wait time Twait3 or not. If Ttimer3≦Twait3, the process proceeds to step S315, where the time Ttimer3 is counted up, and the return spring failure diagnosis 3 is ended. If Ttimer3>Twait3, the process proceeds to step S308. Then, in the same manner as the process from step S107 to step S109 of the example 1, the throttle valve opening ATP is checked, and a fail-safe treatment is performed.

In this way, after the throttle control is stopped, it is judged whether the throttle valve opening ATP is at the mechanical full open position MaxMTP or not, and the time Ttimer3 for which the throttle valve opening ATP is not at the mechanical full open position MaxMTP is measured. Then, if the time Ttimer3 exceeds the wait time Twait3, it is judged that there is a return spring failure. Thus, false detection of a return spring failure can be prevented, as in the example 2.

In other words, since the wait time Twait3 is set at a length of time that is required for the throttle valve 802 to return from the control full close position MinCTP to the mechanical full open position MaxMTP after the throttle control is stopped, any return spring failure is not determined when the throttle valve 802 is returning from the control full close position MinCTP to the mechanical full open position MaxMTP. Thus, false detection of a return spring failure can be prevented.

As described above, according to the example 3, the return spring failure diagnosis is performed after the throttle control is stopped, and if the state where the output value of the throttle sensor does not mean the mechanical full open position continues for a certain length of time, it is judged that there is a return spring failure. Thus, it is possible to prevent false detection of a return spring failure when the throttle valve 802 is returning to the mechanical full open position MaxMTP.

### Example 4

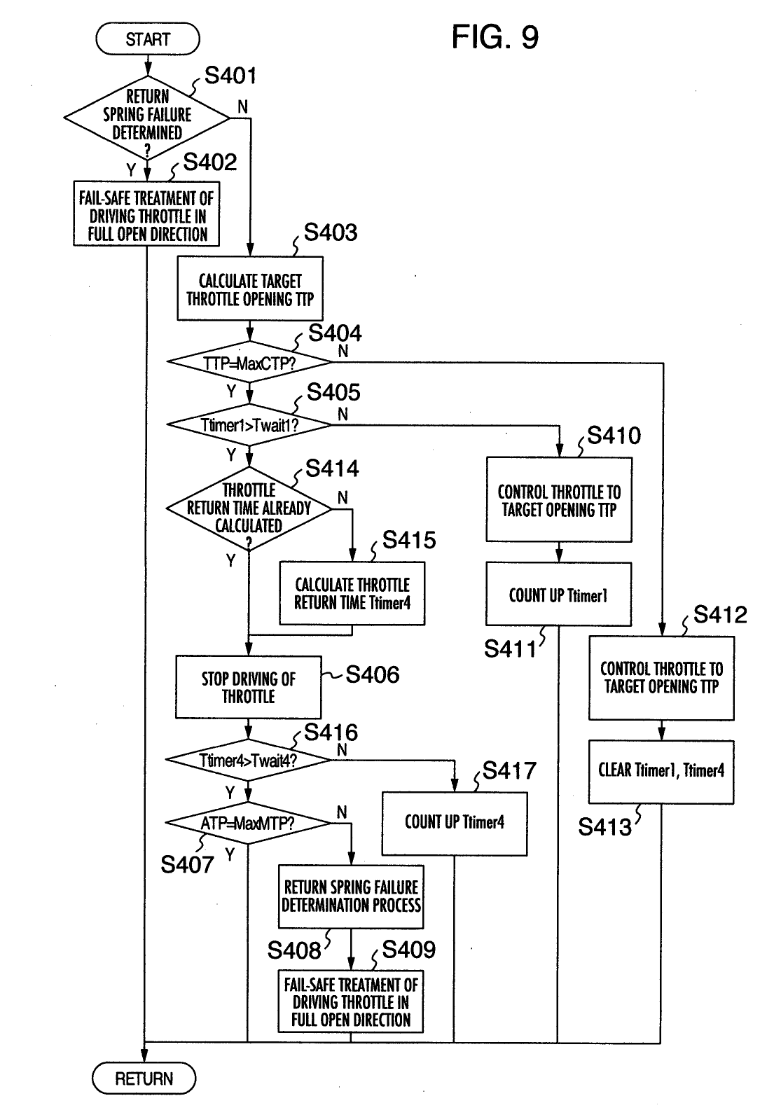

Now, a return spring failure diagnosis process according to example 4 of the invention (referred to as return spring failure diagnosis 2, hereinafter) will be described with reference to FIG. 9. Steps S401 to S413 in FIG. 9 are the same as steps S101 to S113 of the example 1 shown in FIG. 6.

In step S405, it is determined whether the time Ttimer1 for which the throttle is maintained at the control full open position is longer than the wait time Twait1. If Ttimer1>Twait1, the process proceeds to step S414. In step S414, it is judged whether a throttle return time Twait, which is a time required for the throttle valve to return from the throttle valve opening ATP immediately before stop of the throttle control to the mechanical full open position after stop of the throttle control, has already been calculated or not. If the throttle return time Twait4 has not been calculated, the process proceeds to step S415, where the throttle return time Twait4, which is a time required for the throttle valve to return from the throttle valve opening ATP immediately before stop of the throttle control to the mechanical full open position MaxMTP, is calculated. If the throttle return time Twait4 has been calculated, the process proceeds to step S406. Therefore, when the throttle control is stopped, the throttle return time Twait4 is calculated only once.

In step S406, the throttle control is stopped, and then the process proceeds to step S416. In step S416, it is judged whether a lapse time Ttimer4 after stop of the throttle control exceeds the throttle return time Twait4 or not. If Ttimer4≦Twait4, the process proceeds to step S417, where the lapse time Ttimer4 is counted up. If Ttimer4>Twait4, the process proceeds to step S407, and the throttle valve opening ATP is checked in the same manner as the process from step S107 to step S109 in the example 1, and a fail-safe treatment or the like is performed.

In this way, the wait time Twait4 from when the throttle control is stopped to when it is judged whether the throttle valve opening ATP is at the mechanical full open position MaxMTP or not is calculated based on the throttle valve opening ATP immediately before the throttle control is stopped. As a result, as compared with the return spring failure diagnoses according to the examples 1 to 3, determination of a return spring failure can be performed earlier.

Comparing a case where the throttle valve opening ATP is close to the control full open position and a case where the throttle valve opening ATP is close to the control full close position, the wait time is shorter in the case where the throttle opening is close to the control full open position. As compared with the example 2 in which the wait time is set at the certain return time Twait2 required for the throttle valve to return from the control full close position to the mechanical full open position, a return spring failure can be detected early.

As described above, according to the example 4, a predicted return time required for the throttle valve 802 to return to the mechanical full open position MaxMTP is calculated based on the output value of the throttle sensor immediately before the throttle control is stopped, and if the output value of the throttle sensor does not indicates the mechanical full close position when the predicted return time elapses after the throttle control is stopped, it is determined that there is a return spring failure. As a result, a return spring failure can be detected earlier at a failure detection time determined according to the throttle valve opening immediately before the throttle control is stopped.

### Example 5

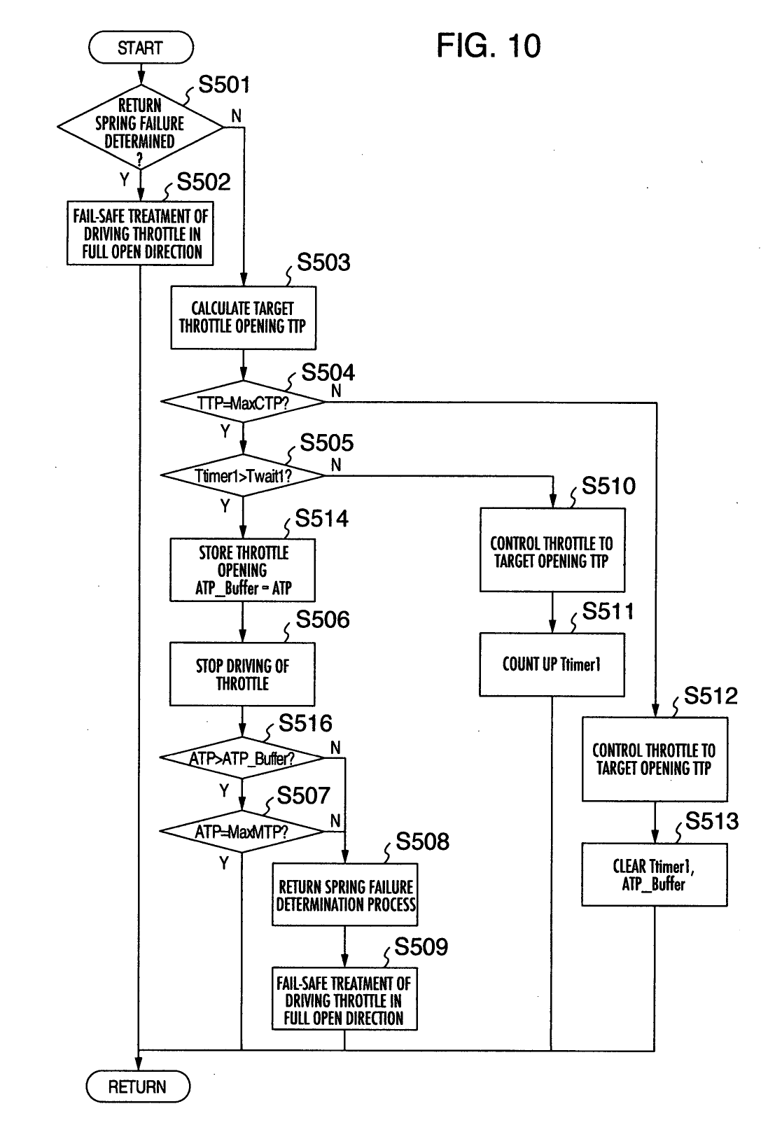

Now, a return spring failure diagnosis according to example 5 of the invention (referred to as return spring failure diagnosis 5, hereinafter) will be described with reference to FIG. 10. Steps S501 to S513 in FIG. 10 are the same as steps S101 to S113 of the example 1 shown in FIG. 6.

In step S505, it is determined whether the time Ttimer1 for which the throttle is maintained at the control full open position is longer than the wait time Twait1, and if Ttimer1>Twait1, the process proceeds to step S514. In step S514, the current throttle valve opening ATP is stored in a throttle-valve-opening buffer ATP_Buffer, and the process proceeds to step S506. In step S506, the throttle control is stopped, and the process proceeds to step S515. In step S515, the current throttle valve opening ATP is compared with the throttle-valve-opening buffer ATP_Buffer immediately before stop of the throttle control. If ATP≦ATP_Buffer, that is, if the throttle valve is operated in the full close direction, it is judged that there is a return spring failure, and the process proceeds to step S508, and a return spring failure determination process and a fail-safe treatment or the like are performed. If ATP>ATP_Buffer, that is, if the throttle valve moves in the full open direction, it is judged that the throttle valve is biased toward the full open position by the return spring and therefore the return spring operates normally, and the process proceeds to step S507. In steps S507 to S509, the throttle valve opening ATP is checked in the same manner as the process from step S107 to step S109 of the example 1, and a fail-safe treatment or the like is performed.

In this way, the throttle valve opening ATP after stop of the throttle control is compared with the throttle-valve-opening buffer ATP_Buffer immediately before stop of the throttle control, and if the throttle-valve-opening buffer ATP_Buffer after stop of the throttle control is operated in the throttle full close direction, that is, in the direction opposite to the direction in which the throttle valve is biased by the return spring 805, it is possible to promptly detect that there is a return spring failure.

As described above, according to the example 5, the throttle valve opening is compared with the output value of the throttle sensor immediately before stop of the throttle control. If the throttle sensor output value is operated in the direction opposite to the direction in which the throttle valve is biased by the return spring 805, it can be determined that the return spring 805 has a failure. Thus, a return spring failure can be detected early.

### Example 6

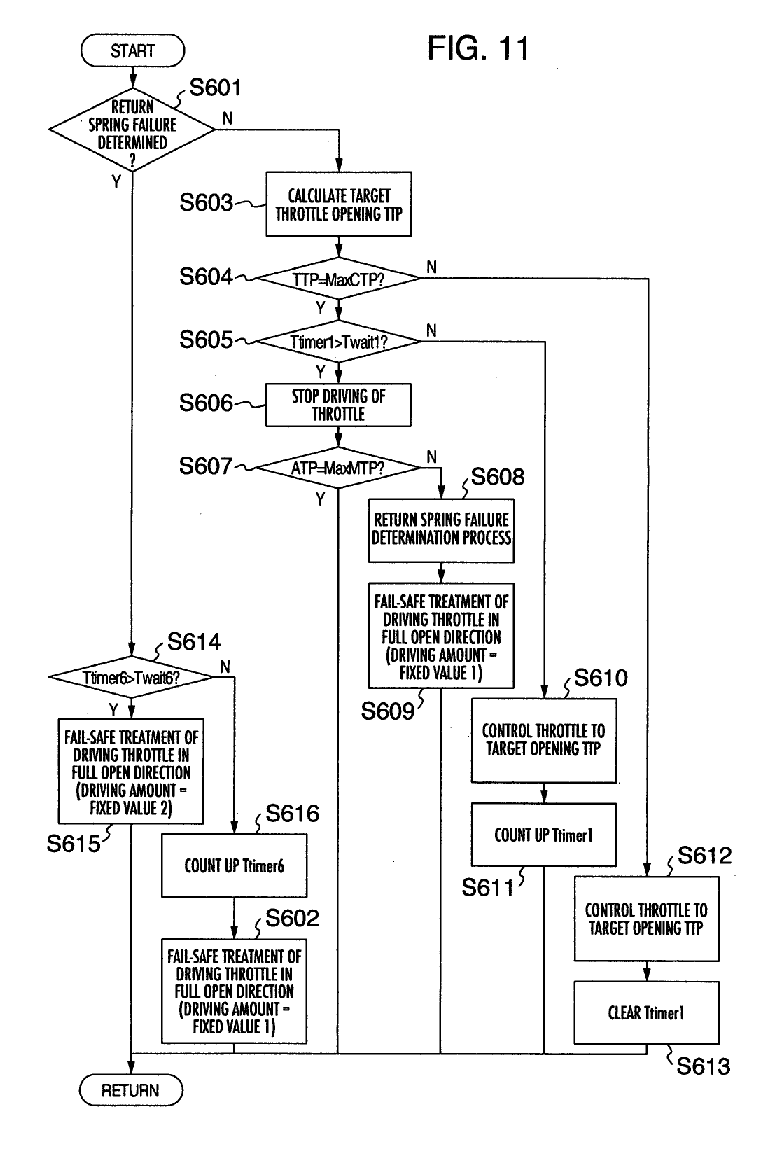

Now, a return spring failure diagnosis according to example 6 of the invention (referred to as return spring failure diagnosis 6, hereinafter) will be described with reference to FIG. 11. Steps S601 to S613 in FIG. 11 are the same as steps S101 to S113 of the example 1 shown in FIG. 6.

In step S601, it is judged whether a return spring failure is determined or not. If a return spring failure is not determined, the process proceeds to step S603. If a return spring failure is determined, the process proceeds to step S614, where it is judged whether a lapse time Ttimer6 after start of a fail-safe treatment is longer than a wait time Twait6 or not.

If Ttimer6≦Twait6, the process proceeds to step S616, and the driving force for driving the throttle valve 802 in the full open direction is set at a fixed value 1. If Ttimer6>Twait6, the process proceeds to step S615, and a driving distance or amount is set at a fixed value 2, and the fail-safe operation continues.

For example, the fixed value 1 is set at a value enough for driving from the control full close position to the mechanical full open position, and the fixed value 2 is set at a value enough for holding the throttle valve 802 at the mechanical full open position. In other words, the fixed value 1 and the fixed value 2 have relation of the fixed value 1>the fixed value 2. In general, the throttle valve 802 is controlled by the motor 803, and the fixed values 1 and 2 are input to the motor driver that controls the motor 803, thereby driving the throttle valve. The motor driver generates more heat when the fixed value 1 is input thereto than when the fixed value 2 is input thereto. Therefore, if the fixed value 1 is continuously input to the motor driver, the heat generated by the motor driver increase. Thus, the heat generation of the motor driver can be reduced by setting the driving amount at the fixed value 2 after the wait time Twait6 elapses.

Further, in the examples 1 to 6, if the target throttle opening TTP is at the control full open position MaxCTP, the throttle control is stopped. However, the target throttle opening TTP for stopping the throttle control is not limited to the control full open position MaxMTP. Furthermore, if the throttle valve opening ATP differs from the mechanical full open position MaxMTP, it is judged that there is a return spring failure. However, the mechanical full open position MaxMTP for determining a return spring failure may be a position different from the mechanical full open position MaxMTP, for example, a position shifted by 1 degree in the close direction from the mechanical full open position MaxMTP.

In the examples 1 to 5, when a return spring failure is determined, the throttle valve 805 is driven toward the mechanical full open position by a fixed value. However, in the example 6, when a predetermined time elapses after the fixed value is output, the fixed value may be decreased, thereby reducing the heat generation of the motor driver for driving the motor.

1. A throttle valve control device, characterized by:
a throttle valve controlling an intake air flow rate of an engine;
a throttle sensor detecting an opening of said throttle valve;
a spring biasing said throttle valve in one arbitrary direction;
a throttle stopper limiting a range of operation of said throttle valve;
a stop means stopping control and driving of said throttle valve in a case where the opening of said throttle valve is larger than a predetermined value or smaller than another predetermined value;
an output value judgment means judging whether or not an output value of said throttle sensor is equal to an output value of said throttle sensor at the time when said throttle valve lies at said throttle stopper, when the control and driving of said throttle valve is stopped; and
a failure judgment means judging that said spring for biasing in the one direction has a failure if the output value of said throttle sensor differs from the output value of said throttle sensor at the time when said throttle valve lies at said throttle stopper.

2. The throttle valve control device according to claim 1, characterized in that said failure judgment means judges that said spring has a failure if a predetermined time elapses after the control and driving of said throttle valve is stopped.

3. The throttle valve control device according to claim 1, characterized in that said throttle valve control device further comprises a measurement means that measures a time for which the output value of said throttle sensor is not equal to the output value of said throttle sensor at the time when said throttle valve lies at said throttle stopper, and
said failure judgment means judges that said spring for biasing in the one direction has a failure if said time for which the output value of said throttle sensor is not equal to the output value of said throttle sensor at the time when said throttle valve lies at said throttle stopper reaches a predetermined time.

4. The throttle valve control device according to claim 1, characterized in that said throttle valve control device further comprises a calculation means that calculates a return time for said throttle valve to return to said throttle stopper based on the output value of said throttle sensor immediately before the control of said throttle valve is stopped, and
said output value judgment means judges whether or not the output value of said throttle sensor is equal to the output value of said throttle sensor at the time when said throttle valve lies at said throttle stopper, when said return time elapses after the control of said throttle valve is stopped.

5. The throttle valve control device according to claim 1, characterized in that said throttle valve control device further comprises:
a storage means storing the output value of said throttle sensor immediately before the control of said throttle valve is stopped; and
a comparison means comparing the stored output value of said throttle sensor and the output value of said throttle sensor after the control of said throttle valve is stopped, and
said failure judgment means judges that said spring for biasing in the one direction has a failure if the output value of said throttle sensor after the control of said throttle valve is stopped is shifted from the stored output value of said throttle sensor in a direction opposite to a direction of biasing by said spring.

6. The throttle valve control device according to claim 1, characterized in that said throttle valve control device further comprises a drive means that drives said throttle valve in the same direction as the direction of biasing by said spring if it is judged that said spring for biasing in the one direction has a failure.

7. The throttle valve control device according to claim 6, characterized in that a driving amount for driving said throttle valve in the same direction as the direction of biasing by said spring is a fixed value.

8. The throttle valve control device according to claim 7, characterized in that said fixed value is changed to another fixed value when a predetermined time elapses after the driving amount is set at said fixed value.

9. A throttle valve control method characterized by steps of:
stopping control and driving of a throttle valve in a case where an opening of said throttle valve is larger than a predetermined value or smaller than another predetermined value;
judging whether or not an output value of a throttle sensor is equal to an output value of the throttle sensor at the time when the throttle valve lies at a throttle stopper, when the control and driving of the throttle valve is stopped; and
judging that a spring for biasing in one direction has a failure if the output value of the throttle sensor differs from the output value of the throttle sensor at the time when the throttle valve lies at the throttle stopper.

10. The throttle valve control method according to claim 9, characterized in that said step of judging that the spring has a failure is performed when a predetermined time elapses after the control and driving of the throttle valve is stopped.

11. The throttle valve control method according to claim 9, characterized in that said throttle valve control method further comprises a step of calculating a return time for the throttle valve to return to the throttle stopper based on the output value of the throttle sensor immediately before the control of the throttle valve is stopped, and
said step of judging whether or not the output value of the throttle sensor is equal to the output value of the throttle sensor at the time when the throttle valve lies at said throttle stopper is performed when said return time elapses after the control of the throttle valve is stopped.

12. The throttle valve control method according to claim 9, characterized in that said throttle valve control method further comprises:
a step of storing the output value of the throttle sensor immediately before the control of the throttle valve is stopped; and
a step of comparing the stored output value of the throttle sensor and the output value of the throttle sensor after the control of the throttle valve is stopped, and
in said step of judging that the spring has a failure, it is judged that the spring for biasing in the one direction has a failure if the output value of the throttle sensor after the control of the throttle valve is stopped is shifted from the stored output value of the throttle sensor in a direction opposite to a direction of biasing by the spring.
